(19) United States
(12) Patent Application Publication
(10) Pub. No.: US 2004/0029998 A1
(43) Pub. Date: Feb. 12, 2004

(54) Radiation shielding material

(76) Inventors: Hitoshi Tomita, Yamaguchi (JP); Tetsuo Nishikawa, Hofu-shi (JP); Kazuo Haruta, Yamaguchi-shi (JP)

Correspondence Address: HOGAN & HARTSON L.L.P., 500 S. GRAND AVENUE, SUITE 1900, LOS ANGELES, CA, 90071-2611, US

(21) Appl. No.: 10/311,606

(22) PCT Filed: Jun. 19, 2001
(86) PCT No.: PCT/JP01/05193

(30) Foreign Application Priority Data
Jun. 20, 2000 (JP) 2000-184804
May 2, 2001 (JP) 2001134905

(51) Int. Cl. G21F 1/10

(52) U.S. Cl. 523/136

(57) ABSTRACT

It is an object of the invention to overcome the problems of the related art and provide a radiation shielding material with no use of lead, which can readily be cut with scissors and the like and can be recycled by again melt molding cut pieces generated from melt molding and cutting with scissors.

In other words, the invention relates to a recyclable radiation shielding material characterized by being produced by melt molding a thermoplastic resin composition containing a thermoplastic elastomer at 2 to 30% by weight and a non-lead inorganic powder of a specific gravity above 4 at 70 to 98% by weight.

### TECHNICAL FIELD

The present invention relates to a radiation shielding material. More specifically, the invention relates not only to a shielding material for radiotherapy but also to a radiation shielding material in the field of atomic energy and a radiation shielding material for use in the field of radiation shield for industrial and medical CT scanning and the like.

### BACKGROUND ART

In case of the use of radiation in the field of medicine, it is required that via the irradiation of radiation at a required level only on an objective site for radiotherapy and measurement without any irradiation on sites never requiring any irradiation of radiation, damages of normal cells and exposure thereof to radiation at a level more than necessary should be prevented. Because the irradiation only on a site as a subject for the irradiation of radiation involves much difficulty, however, shielding materials for shielding radiation are used for sites except for the site requiring the irradiation.

Lead or lead alloys have been used as such radiation shielding materials traditionally. In case that lead or lead alloys are to be used as radiation shielding materials, a method has existed, including preparing a mold so as to prepare a given shape and casting and molding lead or a lead alloy melted under heating at the melting point or more in the mold. Additionally, a method has also existed, including preparing a sphere of lead or a lead alloy having a diameter of about several mm and pouring the resulting sphere into a chase prepared in a given shape. However, these methods are very costly because of the melting of lead, the preparation of the mold therefor and the like so as to obtain a given shape. Additionally, such melting has been problematic in terms of the deterioration of the working environment and its adverse effects on the environment and human bodies.

Furthermore, the resulting molded product may sometimes be remolded because the product never fits to the site of a patient for the irradiation of radiation. Thus, a readily moldable radiation shielding material has been demanded.

So as to prevent X-ray backscattering, a lead sheet of a thickness of 0.1 to 0.2 mm is attached on the X-ray film cassette for medical use. After the use of the cassette, currently, the cassette is disposed while the lead sheet is still attached on it, which therefore draws concerns about its adverse effects on the environment.

So as to protect the bodies of humans working on diagnostic sites using X ray, furthermore, it is required as a matter of duty under regulations to wear X-ray protectors. Lead sheet of a thickness of about 1.5 mm is preliminarily sutured in the protectors. Thus, the adverse effects thereof on the environment during disposal have been drawing concerns.

### DISCLOSURE OF THE INVENTION

It is an object of the invention to overcome the problems of the related art and provide a radiation shielding material with no use of lead, which can readily be cut with scissors and the like.

In other words, the invention relates to a radiation shielding material characterized by including a thermoplastic resin composition containing a thermoplastic elastomer and a non-lead inorganic powder of a specific gravity above 4. The invention will now be described in detail.

### BEST MODE FOR CARRYING OUT THE INVENTION

The thermoplastic elastomer to be used in accordance with the invention contains both of a rubber component with elasticity in the molecule (soft segment) and a molecule restraint component (hard segment) to prevent plastic deformation. The thermoplastic resin composition means a polymer material performing as a rubber elastomer at ambient temperature but being exposed to plastic deformation as the temperature increases, because the molecular motion of the soft segment is retrained locally by the hard segment.

The thermoplastic elastomer to be used in accordance with the invention specifically includes for example polystyrene series containing the hard segment polystyrene and the soft segment polybutadiene, polyisoprene or hydrogenated polybutadiene; polyolefin series containing the hard segment polyethylene or polypropylene and the soft segment ethylene .propylene.diene copolymer (EPDM) or butyl rubber; polyester series containing the hard segment polyester and the soft segment polyether or polyester; polyamide series containing the hard segment polyamide and the soft segment polyester or polyether; polyurethane series containing the hard segment urethane and the soft segment polyester or polyether; and ionomer series containing the hard segment metal carboxylate ion cluster and the soft segment non-crystal polyethylene.

In accordance with the invention, the thermoplastic elastomer is preferably a hydrogenated styrene-based thermoplastic elastomer in which hydrogen atoms are added to the double bond in the principal chain of the soft segment, or a polyester-based thermoplastic elastomer, each exerting sufficient softness even if the soft segment contains an inorganic powder.

Specifically, the non-lead inorganic powder with a specific gravity above 4 for use in the radiation shielding material of the invention includes metals such as iridium, tungsten, iron, stainless steel, zinc, copper, brass, tin, titanium and nickel; metal compounds such as tungsten oxide, iron oxide, zinc oxide, antimony oxide, ferrite, and barium sulfate; and mixtures of two or more thereof. Particularly, tungsten powder or a mixture of tungsten powder and barium sulfate powder is preferable because the radiation shielding performance thereof is high. Furthermore, inorganic powder with a specific gravity below 4 is not practical because satisfactory radiation shielding performance cannot be yielded from such inorganic powder.

In case of molding using injection molding process, the mean particle size (referred to as particle size hereinafter) of the inorganic powder with a specific gravity above 4 for use in the radiation shielding material of the invention is preferably below 300 μm, more preferably below 100 μm, and further more preferably below 30 μm, from the respect that a thermoplastic resin composition readily passing through a mold gate is preferable. When the particle size is of a certain dimension, adversely, the surface area of the inorganic powder is smaller, which enables complete draping of the surface of the inorganic powder with a small amount of a thermoplastic elastomer. In such sense, the particle size is preferably above 2 μm, more preferably above 3 μm.

In case of extrusion molding such as sheet molding, additionally, the particle size is preferably below 100 μm, so that the thermoplastic resin composition can readily pass through a gear pump.

Thus, the particle size of the inorganic powder may appropriately be selected, in view of both moldability and drape. So as to allow the thermoplastic resin composition to get both moldability and drape, for example, the particle size is preferably 2 to 100 μm, more preferably 3 to 30 μm.

So as to enhance the affinity between the inorganic powder and the resin, additionally, coupling process is preferably done before use. As the coupling agent, titanate series, aluminum series, silane series and the like are used. In accordance with the invention, silane-based coupling agents have the highest effect on the improvement of the affinity, and is used preferably.

The blend ratio of the thermoplastic elastomer in the thermoplastic resin composition as the radiation shielding material of the invention is preferably 2% by weight or more. When the blend ratio of the thermoplastic elastomer is above 2% by weight, the resulting thermoplastic resin acquires great softness (at a level such that the resulting radiation shielding material can be molded with scissors) without any fragileness.

The blend ratio of the inorganic powder with a specific gravity above 4 in the thermoplastic resin composition as the radiation shielding material of the invention is preferably 70% by weight or more. When the blend ratio of the inorganic powder with a specific gravity above 4 is above 70% by weight, the resulting radiation shielding material can exert an excellent shielding profile of radiation.

To the thermoplastic resin composition as the radiation shielding material of the invention, furthermore, crystal nucleus agents, lubricants, release agents, anti-oxidants, colorants, flame-retardants, weathering-resistant stabilizers, crosslinking agents and the like may be added.

The method for producing the thermoplastic resin composition as the radiation shielding material of the invention is not specifically limited. Known various methods can be adopted, including for example a process of melting and kneading together an inorganic powder with a specific gravity above 4 and a thermoplastic elastomer, using monoaxial or biaxial extruder. Furthermore, a non-melted thermoplastic elastomer and an inorganic powder with a specific gravity above 4 are preliminarily mixed together in a high-speed agitator; then, the resulting mixture is fed into an extrusion molder and the like, to obtain an extrusion molded product and the like.

The method for producing the radiation shielding material of the invention preferably includes molding the thermoplastic resin composition obtained by the method, using melt molding processes. Among the melt molding processes, particularly, injection molding, extrusion molding and compression molding are preferable.

Furthermore, the molded product obtained by injection molding and the like can be cut into a desired shape with scissors and the like for use, so that the resulting shape may fit to an irradiation site of a patient receiving radiotherapy.

Still furthermore, the radiation shielding material of the invention has high radiation shielding performance and has got appropriate softness securely, so that the radiation shielding material of the invention can preferably be used not only for radiotherapy but also for use in backscattering prevention as an alternative of lead in medical X-ray film cassettes, for use as an alternative of lead sheet preliminarily sutured in X-ray protectors and for use as radiation shielding materials for pipes in atomic power stations and the like. The radiation shielding material of the invention can be used for other diverse uses.

### EXAMPLES

The invention is now described in the following Examples. Herein, radiation shielding performance was assessed by the following method in Examples 1 to 8.

X ray generated in an X-ray generator was allowed to irradiate a sample (a thickness of 6 mm); the transmitting X ray was counted with a dosimeter (Pharma type manufactured by PTW Company) (monitor counts of 200; dose rate of 320; SCD=100 cm; solid water phantom calibration depth (5 cm)).

In Examples 9 and 10, furthermore, radiation shielding performance was counted with a detector (UNIDOS manufactured by PTW Company) positioned apart by 65 cm from a sample, by generating general imaging X ray from a bulb at a 50-kV voltage, a 200-mA electric current and a time period of one second to allow the generated X ray to irradiate the sample positioned apart by 100 cm from the bulb.

Herein, the shield ratios in Examples 1 to 10 were calculated by the formula: [1-(dose of transmitting X ray in the presence of sample)/(dose of X ray in the absence of sample)].

(Silane-based coupling process)

As a silane-based coupling agent, γ-(2-aminoethyl)aminopropyltrimethoxysilane (SH6020; manufactured by Toray.Dow Corning.Silicone (Co., Ltd.)) was used. To a tungsten powder under agitation with a mixer with a high-speed agitation wing (super mixer) was dropwise added the silane-based coupling agent to 0.3% by weight. The agitation was continued, until the temperature inside the mixer reached 120° C. After cooling, subsequently, the resulting tungsten powder was used as a tungsten powder after the silane-based coupling process.

### Examples 1 and 2 and Comparative Example 1

A hydrogenated styrene-based thermoplastic elastomer (Septon 2063 (manufactured by Kuraray Co., Ltd.)) and a tungsten powder of a mean particle size of 13 μm after preliminary silane-based coupling process (manufactured by Tokyo Tungsten Co., Ltd.) were blended together at the ratios shown in Table 1, followed by preliminary mixing with a mixer with a high-speed agitation wing (super mixer) and subsequent melting and kneading with a monoaxial extruder of a screw diameter of 25 mm, to obtain pellets. Using the pellets, molded products of 100 mm×100 mm at a thickness of 1 mm were obtained with an injection molding machine, which were then subjected to the assessment of radiation shielding performance. Furthermore, the molded products were cut with scissors. Consequently, Comparative Example 1 was fragile with no remaining shape.

TABLE 1

| | Blend amount of tungsten | |
|---|---|---|
| | (% by weight) | Shielding ratio |
| Example 1 | 97 | 0.30 |
| Example 2 | 95 | 0.28 |
| Example 3 | 88 | 0.22 |
| Comparative Example 1 | 98.5 | — |

### Example 3

A polyester thermoplastic elastomer (Perprene P-90B (manufactured by Toyobo Co., Ltd.) and a tungsten powder of a mean particle size of 5 μm after preliminary silane-based coupling process (manufactured by Tokyo Tungsten Co., Ltd.) were blended together at 12% by weight and 88% by weight, respectively, to obtain pellets by the same method as in Example 1. Using the pellets, molded products were obtained by the same method as in Example 1 and were then subjected to the assessment of radiation shielding performance. The results are shown in Table 1. Furthermore, the molded products could readily be cut with scissors.

### Examples 4 to 8 and Comparative Example 2

The styrene-based thermoplastic elastomer used in Example 1 and inorganic powders after preliminary coupling process as shown in Table 2 were blended together at 15% by weight and 85% by weight, respectively, to obtain pellets by the same method as in Example 1. Using the pellets, the pellets were applied to a sheet molding machine, to obtain sheets of a thickness of 0.5 mm and a width of 300 mm. In the same manner as in Example 1, the radiation shielding performance of the resulting sheets was evaluated. The results are shown in Table 2.

TABLE 2

| | Inorganic powder | |
|---|---|---|
| | (specific gravity) | Shielding ratio |
| Example 4 | iron (7.87) | 0.08 |
| Example 5 | stainless steel (7.87) | 0.08 |
| Example 6 | barium sulfate (4.5) | 0.07 |
| Example 7 | zinc oxide (5.5) | 0.08 |
| Example 8 | soft ferrite (4.6) | 0.07 |
| Comparative Example 2 | aluminium (2.7) | 0.04 |

Manufacturers of the inorganic powders

Iron: Kawasaki-steel Co., Ltd.

Stainless steel: Daido Steel Co., Ltd.

Barium sulfate: Sakai Chemical Industry Co., Ltd.

Zinc oxide: Sakai Chemical Industry Co., Ltd.

Ferrite: Toda Kogyo Corp.

Aluminium: Fukuda Metal Foil & Powder Co., Ltd.

### Examples 9 and 10

The styrene-based thermoplastic elastomer used in Example 1 and inorganic powders after preliminary coupling process as shown in Table 3 were blended together at compositions shown in Table 3, to obtain pellets in the same manner as in Example 1. Sheets of a thickness of 0.5 mm and a width of 300 mm were then obtained in the same manner as in Example 4. The radiation shielding performance of the resulting sheets was assessed. The results are shown in Table 3.

TABLE 3

| | Composition of inorganic powder | | | Shielding |
|---|---|---|---|---|
| | | | specific | ratio |
| | Tungsten | barium sulfate | gravity | (%) |
| Example 9 | 78.5% by weight | 0% by weight | 3.5 | 0.93 |
| Example 10 | 61.5% by weight | 20% by weight | 3.5 | 0.90 |

Tungsten: tungsten used in Example 1.

Barium sulfate: barium sulfate used in Example 6.

As described above, in accordance with the invention, the radiation shielding material exerts great shielding performance. For medical use in particular, the radiation shielding material can be cut freely with scissors and the like without any handling of toxic lead. Hence, the radiation shielding material can shield sites except for a site of a patient requiring radiotherapy from radiation. Additionally, the radiation shielding material still keeps appropriate softness. Therefore, the radiation shielding material can be used not only for radiotherapy but also for use in backscattering prevention as an alternative of lead in medical X-ray film cassettes, for use as an alternative of lead sheet preliminarily sutured in X-ray protectors and for use as radiation shielding materials for pipes in atomic power stations and the like. The radiation shielding material of the invention can be used for other diverse uses. Furthermore, cut pieces thereof can be melted and molded again for recycling.

### INDUSTRIAL APPLICABILITY

As described above, the inventive radiation shielding material can exert great radiation shielding performance, so the radiation shielding material can be used as an alternative material of radiation shielding materials made of toxic lead and lead alloys. Because the radiation shielding material has excellent softness, furthermore, the radiation shielding material can readily be cut into a desired shape with scissors and the like, while cut pieces from melt molding and cutting with scissors can be recycled via regeneration through melt molding, advantageously.

1. A radiation shielding material characterized by including a thermoplastic resin composition containing a thermoplastic elastomer and a non-lead inorganic powder with a specific gravity above 4.

2. A radiation shielding material according to claim 1, characterized in that the ratio of the thermoplastic elastomer is 2 to 30% by weight and the ratio of the non-lead inorganic powder with a specific gravity above 4 is 70 to 98% by weight.

3. A radiation shielding material according to claim 1 or 2, characterized by being produced by melt molding.

4. A radiation shielding material according to claim 3, characterized in that the melt molding is done by a molding method selected from any one of injection molding, extrusion molding and compression molding.
